(19) United States
(12) Patent Application Publication
(10) Pub. No.: US 2011/0186461 A1
(43) Pub. Date: Aug. 4, 2011

(54) PACKAGING

(75) Inventor: Patrick Jules Joseph Poitevin, Birmingham (GB)

(73) Assignee: Cadbury UK Limited

(21) Appl. No.: 13/063,481

(22) PCT Filed: Sep. 10, 2009
(86) PCT No.: PCT/GB09/02191

§ 371 Date: Apr. 15, 2011

(30) Foreign Application Priority Data
Sep. 16, 2008 (GB) 0816877.5

(51) Int. Cl. B65D 73/00; B31B 1/26; B65B 43/00

(52) U.S. Cl. 206/475; 493/162; 53/452

(57) ABSTRACT

A packaging container (10) formed from at least one blank of foldable material has a base (16) and side walls (18) which define an interior volume in which packaged products (26) are contained for transport and display purposes. The base has a plurality of inwardly extending protrusions (74) for engagement with the products to prevent them slipping whilst on display. The protrusions (74) may be formed by embossing the base or by means of die-cut tabs in the base which are pressed inwardly. The container (10) may be transported and/or stored on its side or whilst inverted so that the products do not flatten the protrusions.

### TECHNICAL FIELD OF THE INVENTION

The present invention relates to a packaging container for transporting and/or displaying a plurality of packaged products. The invention also relates to a method of forming the container, to a blank of foldable material for forming at least part of the container and to the combination of a packaging container and a plurality of individually packaged products.

### BACKGROUND TO THE INVENTION

It is known to use packaging containers, such as paperboard or cardboard boxes, cartons and trays, for storing and transporting individually packaged products. A number of individually packaged products are placed in the packaging container which may be closed by means of a separate, removable lid or by means of an integral folded top closure for transport to a retail outlet or other destination. At the retail outlet the container package is opened to display the products and placed on a shelf without having to remove the individual products from the container.

A wide range of products are stored and transported in this way, including: confectionery, snack foods, cereals, household goods, cosmetics and other personal care products, for example.

In order to display the products, it is desirable that they are positioned in the container in a generally upright or inclined condition. However, products which have a relatively small base are unstable in the packaging container and have a tendency to fall over or to slip down once a number of the products have been removed from the container.

There have been attempts to solve this problem by modifying the base of the packaging container to support the individually packaged products or by coating the base with an anti-slip material. However, the known arrangements tend to be quite complex, often involving inserts to support the products, which results in increased manufacturing costs. GB 2 240 321 A for example discloses a cardboard tray having a series of slits across the base of the tray connected by creases extending along the length of the tray. This gives the base a saw-tooth configuration along its length to provide support for the products.

There is a need, therefore, for an alternative packaging container which provides support for individually packaged products which overcomes, or at least mitigates one or more of the drawbacks of the known arrangements.

There is also a need for improved methods of forming and filing packaging containers which overcome, or at least mitigate, some or all of the drawbacks of the known arrangements.

### SUMMARY OF THE INVENTION

In accordance with a first aspect of the invention, there is provided a packaging container for transporting and/or displaying a plurality of individually packaged products, the container being formed from at least one blank of foldable material and comprising at least a base and side walls defining an interior volume for holding the products, the base having a plurality of inwardly extending protrusions for engagement with the products.

Each protrusion may comprise part of the material of the base which has been pressed inwardly out of the plane of the base from the exterior of the base.

Protrusions may be provided over substantially the whole (80% or more) of the inner surface of the base. However, in some embodiments, protrusions may be provided over up to about 75% of the inner surface of the base. In alternative embodiments, protrusions may be provided over up to about 50%, 45%, 40%, 35%, 30%, 25%, 20%, 15%, 10% or 5% of the inner surface of the base.

The protrusions may be provided in least two discreet regions of base which may extend longitudinally of the container. The protrusions may be provided in two discreet regions of the base that are located either side of a central region in which there are no protrusions.

The protrusions may be arranged in rows extending in a lateral direction of the container.

In one embodiment the protrusions are formed by embossing the inner surface of the base.

The term “embossed” is intended to mean a surface which has been embellished with one or more raised features. It will be apparent to the skilled addressee that the inner surface of the base may be embossed to provide a plurality of protrusions by debossing an outer surface of the base.

Each protrusion may be perforated.

The term “perforated” is intended to mean pierced with one or more holes.

Each protrusion may be generally circular in plan and may have a hole at its centre.

Each protrusion may have a depression surrounding the hole.

In an alternative embodiment, each protrusion comprises a tab formed in the base and foldably connected with the remainder of the base, the tab extending into the container. In this embodiment, each tab may be inclined inwardly of the container relative to the plane of the base in a direction from a front end of the container towards a rear end.

The container may have a product display portion comprising the base and the side walls and having an open top, the container may also have a separate lid portion mountable to the product display portion to enclose the products within the product display portion.

The product display portion may be formed from a single blank of foldable material.

In accordance with a second aspect of the invention, there is provided a combination of a packaging container in accordance with the first embodiment and a plurality of individually packaged products within the interior volume of the container, a lower end of the products engaging with the protrusions.

The lower end of each product may have a smaller cross sectional area than a face of the product which is directed generally towards the front of the container. The products may be generally block shaped and arranged in either landscape or portrait. The products may be chocolate bars.

In accordance with a third aspect of the invention, there is provided a method of forming a packaging container for transporting and/or displaying a plurality of individually packaged products, the method comprising:

a. folding a blank of material to form a base and side walls defining an interior volume for holding the products;

b. forming a plurality of inwardly projecting protrusions on the base, each protrusion being formed by deforming the material of the base inwardly out of the plane of the base.

The protrusions may be formed after the step of folding the blank of material to form a base and side walls defining an interior volume for holding the products.

The method may also comprise the step of introducing a plurality of individually packaged products into the interior volume of the container, and the step of forming the protrusions may be carried out after the products have been introduced into the interior volume of the container.

The step of forming a plurality of protrusions may involve bringing a press having a number of protrusions into contact with the exterior surface of the base and applying a pressure such that each protrusion on the press deforms a region of the material of the base inwardly out of the plane of the base. The protrusions on the press may terminate in a rod or needle and sufficient pressure applied that the rods or needles puncture the base to produce a hole in the centre of each protrusion. In this case, the method may also comprise withdrawing the press after the needles or rods have punctured the base so as to pull back the material surrounding the needle to create a depression in the end of each protrusion surrounding the hole as the rods or needles are withdrawn.

In an alternative embodiment, the method comprises die-cutting a plurality of tabs in the base prior to the step of folding a blank of material to form a base and side walls defining an interior volume for holding the products and subsequently pressing the tabs out of the plane of the base to project inwardly of the container to form the protrusions. The tabs may be pressed inwardly after the blank has been folded to form a base and side walls defining an interior volume for holding the products. The tabs may be pressed inwardly after the plurality of individually packaged products have been introduced into the interior volume of the container.

The method may comprise storing and transporting the filled container with the container positioned on a side or inverted.

In accordance with a fourth aspect of the invention, there is provided a method of filling a packaging container for transporting and/or displaying a plurality individually packaged products, the method comprising:

a. supplying a container comprising a product display portion having a base and side walls defining an interior volume and a lid portion having a top and side walls defining an interior volume:

b. introducing a plurality of individually packaged products into the lid whilst the lid is inverted;

c. fitting the product display portion to the inverted lid so as to enclose the products;

d. bringing a press in to contact with an exterior surface of the base of the product display portion to produce a plurality of protrusions extending inwardly of the container from the plane of the base.

The step of pressing the exterior surface of the base of the product display portion may be carried out before or after the product display portion is fitted to the lid.

In one embodiment, the method comprises bringing a press having a number of protrusions into contact with the exterior surface of the base of the product display portion and applying a pressure so as to deform the material of the base to produce a plurality of protrusions on the inner surface of the base. The protrusions on the press may terminate in a rod or needle and sufficient pressure may be applied that the rods or needles puncture the base to produce a hole in the centre of each protrusion. In this case, the method may also comprise withdrawing the press after the needles or rods have punctured the base so as to pull back the material surrounding the needle to create a depression in the end of each protrusion surrounding the hole as the rods or needles are withdrawn.

In an alternative embodiment, the base of the product display portion comprises a plurality of die-cut tabs and the method comprises bringing a press having a number of protrusions into contact with the exterior surface of the base of the product display portion and applying a pressure so as to press the tabs inwardly.

The method may comprise transporting and/or storing the filled container on its lid.

The method may comprise:

a. turning the filled container upright;

b. removing the lid so as to leave the products contained within the product display portion;

c. displaying the products in the product display portion.

The lid may be removed before or after the product display portion is positioned for display.

In accordance with a fifth aspect of the invention, there is provided a unitary blank of foldable material for producing a packaging container for transporting and/or displaying a plurality of individually packaged products in accordance with the first aspect of the invention or for use in the methods according to either of the third and fourth aspects of the invention, the blank comprising a base panel portion for forming a base of the container and side wall portions for forming side walls of the container, in which a plurality of die cut tabs for forming the protrusions are provided in the base panel portion.

### DETAILED DESCRIPTION OF THE INVENTION

Several embodiments of the invention will now be described, by way of example only, with reference to the accompanying drawings, in which:

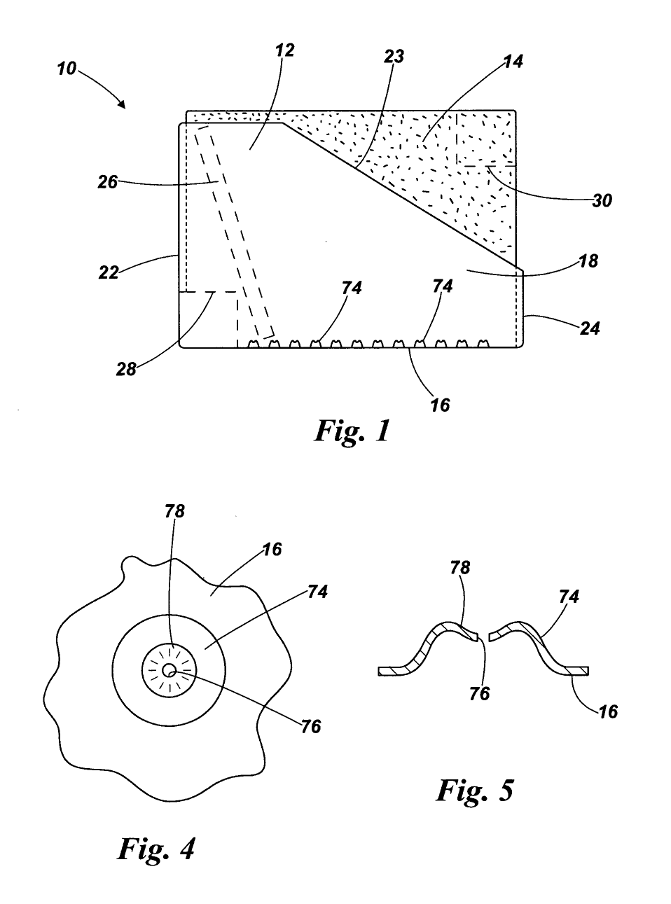

FIG. 1 is a schematic side elevation of a packaging container in accordance with a first embodiment of the invention, showing various internal details of the container in dashed lines;

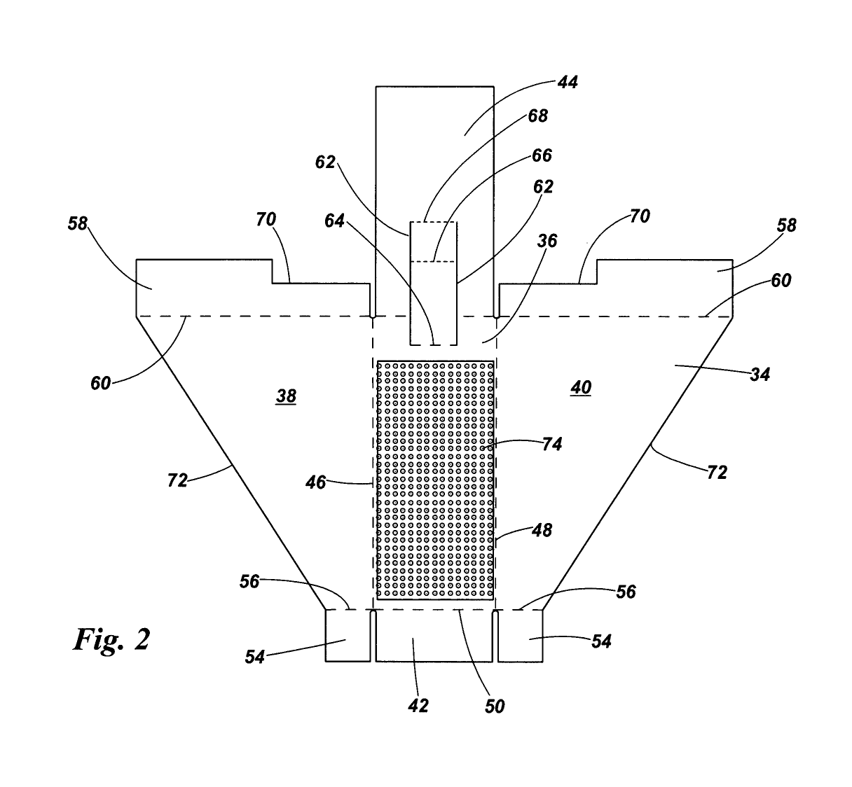

FIG. 2 is a plan view of a blank for forming a product display portion of the packaging container of FIG. 1, in which substantially the whole of the inner surface of the base is embossed;

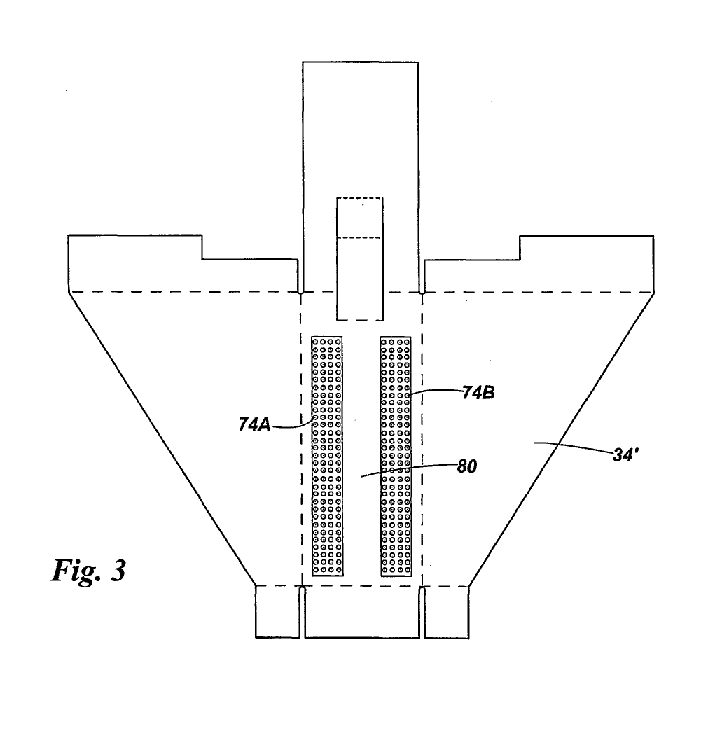

FIG. 3 is a view similar to that of FIG. 2 but illustrating a modified embodiment in which two discreet regions of the inner surface of the base are embossed;

FIG. 4 is a plan view of a protrusion embossed onto the inner surface of the base of the container of FIG. 1;

FIG. 5 is a cross sectional view through the protrusion of FIG. 4, taken on line X-X;

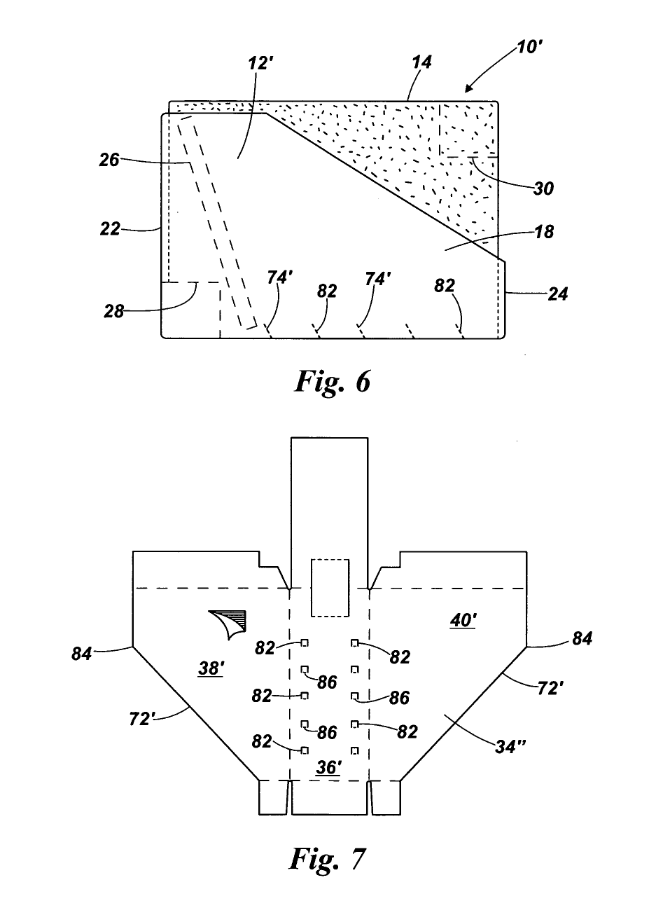

FIG. 6 is a view similar to that of FIG. 1 showing an alternative embodiment of a packaging container in accordance with the invention, in which the protrusions are formed by means of die-cut tabs in the base; and,

FIG. 7 is a plan view of a blank for forming the product display portion of the packaging container of FIG. 6.

With reference initially to FIGS. 1 to 6, a packaging container 10 for transporting and/or displaying a plurality of individually packaged products in accordance with a first embodiment of the invention has a product display portion 12 and a lid portion 14.

The product display portion 12 has a base 16, opposed side walls 18, a rear wall 22 and a front wall 24, which together define an interior volume for receiving a number of individually packaged products 26.

The lid portion 14 is in essence a mirror image of the product display portion having a base or top with side walls defining an internal volume. The lid portion is sized to fit over or inside the walls of the product display portion to fully enclose the products for storage and transportation purposes. In a retail outlet, the lid 14 can be removed and the product display portion 12 placed directly on a shelf to display the products without having to remove the products 26 from the container.

In order that the products 26 can be clearly seen when the product display portion 12 is positioned on a shelf, the front wall 24 is shorter than the rear wall 22 and the upper edges 23 of the side walls 18, angle upwardly from the front wall 24 towards the rear wall 22. In addition, the product display portion 12 has a kick-in 28 at the junction between the base 16 and the rear wall 22 to hold the products at an angle so that the upper ends of the products 26 are tilted backwardly towards the rear wall 22. A corresponding kick-in 30 is provided on the lid portion 14. Inclining the products 26 in this way ensures that the products 26 are presented at an optimum viewing angle for displaying on a low shelf. However, in alternative embodiments the products 26 can be arranged to be held substantially upright in the product display portion 12 and the kick-ins 28, 30 omitted.

In FIG. 1, only a single individually packaged product 26 is shown for clarity but it will be appreciated that when full, the product display portion 12 can hold a number of products 26 depending on the size of the product and the size of the container. In the present embodiment, the products 26 are chocolate bars and typically the product display portion will be sized to hold 5 to 35, 10 to 32, or 14 to 30 bars. However, it will be appreciated that the container 10 could be configured to hold fewer or more products depending on the size of the products and the size of the shelf on which the product display portion 12 is to be placed for display purposes.

The product display portion 12 and the lid 14 are each formed from a single blank of foldable material such as cardboard, paperboard or the like. A blank 34 for forming the product display portion 12 is shown in FIG. 2. The blank comprises a central base panel 36, two side wall panels 38, 40, a front wall panel 42 and a rear wall panel 44. The side wall panels 38, 40 and the front and rear wall panels 42, 44 are each connected with the base panel via a respective fold line 46, 48, 50, 52. Each of the side wall panels 38, 40 is connected with a front wall tab 54 by means of a fold line 56 and a rear wall tab 58 by means of a fold line 60.

To form the blank 34 into the product display portion, the side wall panels 38, 40 are folded upwardly (as shown in FIG. 2) about their respective fold lines 46, 48. The front and rear wall tabs 54, 58 are folded inwardly about their respective fold lines 56, 58 and the front a rear wall panels 42, 44 are folded upwardly (as shown). The inner surfaces of the front and rear wall panels 42, 44 are bonded to the outer surfaces of the front and rear wall tabs 54, 58 using an adhesive to secure the side wall panels 38, 40 and the front and rear wall panels 42, 44 in position so as to define an internal volume. Any suitable adhesive can be used which may be heat and/or pressure sensitive. The adhesive may be pre-applied to the blank prior to folding or it may be applied whilst the blank is being formed into the product display portion.

The kick-in 28 is defined by means of two cut lines 62 which extend along a lower portion of the rear wall panel 44 and into the base panel 36 and by three fold lines 64, 66, 68. The kick-in 28 is formed by pressing in the region between the cut lines 62 once the rear wall panel has been folded into position, in a manner known in the art. The rear wall tabs 58 are shaped with cut out regions 70 so as to fit around the kick-in 28.

In the blank 34 as shown in FIG. 2, the upper edges 72 of the side wall panels 38, 40 are angled from the front edge to rear edge. This differs from the arrangement as shown in FIG. 1, in which the upper edges of the side walls are angled from the front end to a position just over half-way from the front to the rear. Either of these arrangements can be adopted.

In the present embodiment, the container 10 is configured to hold a single row of rectangular products 26 in portrait, that is to say with one of their short edges lowermost. Accordingly, the base 16 is relatively narrow. However, the container 10 could be adapted to hold the products 26 in landscape, with one of the longer edges lowermost instead. Alternatively, or in addition, the container could be configured to hold more than one row of products 26.

The blank for forming the lid 14 is similar to the blank 34 for the product display portion 12 but appropriately sized so that the walls of the lid can fit over or be received inside the walls of the product display portion.

When the product display portion 12 is full, the products 26 are held between the front and rear walls and the kick-in 28 and so remain at the desired angle of inclination. However, once on display, products 26 are removed from the product display portion by customers and there is a risk that the remaining products may slip down so that they are no longer presented at the optimum angle and may be difficult for customers to remove. To help in resisting such slippage, the inner surface of the base 16 is provided with a plurality of protrusions 74. The protrusions 74 engage the lower end of the products 26 to reduce the likelihood of the lower ends of the products 26 slipping forward.

The protrusions 74 may be arranged to cover substantially the whole of the base (more than 80%) as is illustrated in FIG. 2. However, in some embodiments, up to about 75% of the inner surface of the base may be embossed or contain protrusions.

In alternative embodiments, up to about 50%, 45%, 40%, 35%, 30%, 25%, 20%, 15%, 10% or 5% of the inner surface of the base is embossed or contain protrusions.

The protrusions may be spread evenly over substantially the whole of the inner surface of the base as illustrated in FIG. 2. Alternatively, as illustrated in FIG. 3, protrusions 74 may be provided in two discrete regions 74A, 74B extending longitudinally along either side of the base 16. This provides a central region 80 on the base which does not have protrusions and on which bar codes or other information may be printed or otherwise provided. The blank 34′ shown in FIG. 3 is otherwise identical to the blank 34 shown in FIG. 2 and described above.

The protrusions 74 can be of any suitable shape and may be arranged in rows extending laterally across the base 16 so that the lowermost ends of the products 26 locate between adjacent rows.

In the present embodiment, the protrusions are formed by embossing the inner surface of the base. Embossing in this case is undertaken using a pressing machine (not shown) having a number of protrusions and which is brought into contact with the outer surface of the base 16 so as to deform the material inwardly to form the protrusions 74. Although the protrusions 74 on the base 16 can be of any suitable shape, in the present embodiment the protrusions 74 are generally circular in plan having a central hole 76 and a small depression 78 is formed at the apex of each protrusion around the hole as shown in FIGS. 4 and 5. This shape gives the protrusions 74 greater structural rigidity than would be the case with a simple, dimple shaped protrusion, for example.

To form protrusions 74 having this shape, the protrusions on the pressing machine terminate in a rod or needle. As the press is brought into contact with the outer surface of the base 16, the material in the base is deformed inwardly by the protrusions on the press until the rods or needles eventually puncture the material. The press is then retracted and the rods/needles pull back the material slightly in an area around the puncture before being withdrawn fully from the material.

Arrangements for filling the container 10, producing the protrusions 74 and transporting/storing the container are advantageously organised so that the products 26 do not contact and flatten the protrusions 74 as the products are introduced into the container or during storage and transportation of the filled container.

In a first method of filing and transporting the container 10, the products 26 are introduced into the product display portion 12 and the lid portion 14 fitted. The filled container 10 is then inverted or placed on its side or inverted and the base 16 of the product display portion embossed to produce the protrusions 74. The filled and embossed container can then be stored and/or transported on its side or in an inverted condition. Prior to being placed on display, the container 10 is turned the right way up and the lid portion 14 removed leaving the products in the product display portion 12.

In an alternative method, the products 26 are introduced into the lid portion 14 whilst it is inverted and the product display portion 12 is fitted to the lid portion 14 to enclose the products. The filled container 10 can then be stored and/or transported on its lid 14 or on its side and need only be turned the right way up when the products are to be displayed. In this embodiment, the base 16 of the product display portion 12 can be embossed either before the product display portion is fitted to the lid portion 14 or afterwards. The base 16 could be embossed prior to or during the process of forming the blank 34, 34′ into the product display portion 12 if desired.

These arrangements minimise the chances of the protrusions 74 being compressed, reducing their effectiveness, before the products 26 are placed on display.

An alternative embodiment of a packaging container 10′ in accordance with the invention is illustrated in FIG. 6. The packaging container 10′ in accordance with the alternative embodiment is essential the same as the embodiment 10 described above with reference to FIG. 1, except that protrusions 74′ are formed by means of tabs 82 in the base 16 of the product display portion 12′ which are pressed out of the plane of the base to engage with products 26.

FIG. 7 illustrates a blank 34″ for forming the product display portion 12′ of the container 10′. The blank 34″ is similar to the blanks 34, 34′ described above and so will not be described in detail. However, it will be noted that in the blank 34″, the “upper” edges 72′ of the side wall panels 38′, 40′ angle from their front end to a point 84 part way between their front and rear ends and so will produce side walls shaped as shown in FIGS. 1 and 6.

The central base panel 36′ of the blank 34″ is provided with two spaced rows of die-cut tabs 82. Each tab 82 is produced by forming a squared off, generally U-shaped cut in the base so that the tab remains connected to the base by means of a fold line 86 which extends generally parallel to the front wall 24. To form the protrusions 74′, the tabs 82 are pressed inwardly about their fold lines 86 out of the plane of the base so as to project into the container. As shown in FIG. 6, when the tabs 82 are pressed in to form the protrusions 74′, they are inclined inwardly of the container relative to the plane of the base in a direction from a front end of the container 24 towards a rear end 22. With this arrangement, the lower ends of the products 26 contact the free ends of the tabs to reduce the likelihood of the products slipping down in the container.

In the embodiment shown in FIGS. 6 and 7, there are 10 tabs 82 arranged in two longitudinal columns to form five lateral rows. However, the number of tabs 82 and their disposition on the base can be varied as required.

The tabs 82 can be pressed out of the plane of the base 16 by any suitable method, including use of a press having a corresponding number of protrusions for engagement with the tabs.

As with the container 10 having embossed protrusions 74, the arrangements for filling the container 10′, producing the protrusions 74′ and for transporting/storing the container are advantageously organised so that the products 26 do not contact and flatten the protrusions 74′ as the products are introduced into the container or during storage and transportation of the filled container.

Conveniently, the tabs 82 will be die-cut in the blank 34″ prior to the blank being folded. Where the container is to be filled in accordance with the first method discussed above in which the products 26 are introduced into the product display portion 12′ and lid portion 14 fitted, the filled container 10′ can be inverted or placed on its side and the tabs 82 pressed inwardly to form the protrusions 74′. The filled container with the protrusions formed can then be stored and/or transported on its side or in an inverted condition.

Where the container 10′ is filled using the alternative method, in which the products 26 are introduced into the lid portion 14 whilst it is inverted and the product display portion 12′ fitted to the lid portion 14 to enclose the products, the tabs 82 can be pressed inwardly as part of the process of folding the blank 34″ to form the product display portion or at some point prior to the product display portion being fitted to the lid portion. Alternatively, the tabs 82 could be pressed in after the product display portion 12′ has been fitted to the lid. The filled container 10 with the protrusions 74 formed can then be stored and/or transported on its lid 14 or on its side.

Prior to being placed on display, the container 10′ is turned the right way up and the lid portion 14 removed leaving the products in the product display portion 12′.

Containers in accordance with the invention are easy to manufacture requiring no additional inserts or complex folding operations to produce formations for supporting the products 26 to reduce slippage.

It will be appreciated that invention as described in its various embodiments can be applied in a wide variety of packaging/display containers, including containers having an integral lid or upper closure rather than a separable lid portion 14.

Whilst containers in accordance with the invention are particularly suitable for packaging/displaying confectionery products such as chocolate bars, the concept can be readily adapted to package/display a wide variety of products.

The foregoing embodiments are not intended to limit the scope of protection afforded by the claims, but rather to describe examples as to how the invention may be put into practice.

1. A packaging container for transporting and/or displaying a plurality of individually packaged products, the container being formed from at least one blank of foldable material and comprising at least a base and side walls defining an interior volume for holding the products, the base having a plurality of inwardly extending protrusions for engagement with the products.

2. A packaging container as claimed in claim 1, in which each protrusion comprises part of the material of the base which has been pressed inwardly out of the plane of the base from the exterior of the base.

3. A packaging container as claimed in claim 1, in which the protrusions are provided over substantially whole of the base.

4. A packaging container as claimed in claim 1, in which the protrusions are provided in least two discreet regions of base.

5. A packaging container as claimed in claim 4, in which each discreet region extends longitudinally of the container.

6. A packaging container as claimed in claim 5, in which the protrusions are provided in two discreet regions of the base, the two discreet regions being located either side of a central region in which there are no protrusions.

7. A packaging container as claimed in claim 1, in which the protrusions are arranged in rows extending in a lateral direction of the container.

8. A packaging container as claimed in claim 1, in which each protrusion is perforated.

9. A packaging container as claimed in claim 8, in which each protrusion is generally circular in plan and has a hole at its centre.

10. A packaging container as claimed in claim 9, in which each protrusion has a depression surrounding the hole.

11. (canceled)

12. A packaging container as claimed in claim 1, in which each protrusion comprises a tab formed in the base and which is foldably connected with the remainder of the base, the tab projecting into the container.

13. A packaging container as claimed in claim 12, in which each tab is inclined inwardly of the container relative to the plane of the base in a direction from a front end of the container towards a rear end.

14. A packaging container as claimed in claim 1, the container having a product display portion comprising the base and the side walls and having an open top, the container also comprising a separate lid portion mountable to the product display portion to enclose the products within the product display portion.

15. A packaging container as claimed in claim 14, in which the product display portion is formed from a single blank of foldable material.

16.-20. (canceled)

21. A method of forming a packaging container for transporting and/or displaying a plurality of individually packaged products, the method comprising:
a. folding a blank of material to form a base and side walls defining an interior volume for holding the products;
b. forming a plurality of inwardly projecting protrusions on the base, each protrusion being formed by deforming the material of the base inwardly out of the plane of the base.

22. A method as claimed in claim 21, in which the protrusions are formed after the step of folding the blank of material to form a base and side walls defining an interior volume for holding the products.

23. A method as claimed in claim 21 further comprising the step of introducing a plurality of individually packaged products into the interior volume of the container, in which the step of forming the protrusions is carried out after the products have been introduced into the interior volume of the container.

24. A method as claimed in claim 23, in which the step of forming a plurality of protrusions involves bringing a press having a number of protrusions into contact with the exterior surface of the base and applying a pressure such that each protrusion on the press deforms a region of the material of the base inwardly out of the plane of the base.

25. A method as claimed in claim 24, in which the protrusions on the press terminate in a rod or needle and sufficient pressure is applied that the rods or needles puncture the base to produce a hole in the centre of each protrusion.

26. A method as claimed in claim 25, the method further comprising withdrawing the press after the needles or rods have punctured the base so as to pull back the material surrounding the needle to create a depression in the end of each protrusion surrounding the hole as the rods or needles are withdrawn.

27. A method as claimed in claim 23, in which method comprises die cutting a plurality of tabs in the base prior to the step of folding a blank of material to form a base and side walls defining an interior volume for holding the products and subsequently pressing the tabs out of the plane of the base to project inwardly of the container to form the protrusions.

28. A method as claimed in claim 27, in which the tabs are pressed inwardly after the blank has been folded to form a base and side walls defining an interior volume for holding the products.

29. A method as claimed in claim 27, in which the tabs are pressed inwardly after the plurality of individually packaged products have been introduced into the interior volume of the container.

30.-31. (canceled)

32. A method of providing a packaging container for filling, transporting and/or displaying a plurality individually packaged products, the method comprising:
a. supplying a container comprising a product display portion having a base and side walls defining an interior volume and a lid portion having a top and side walls defining an interior volume:
b. introducing a plurality of individually packaged products into the lid whilst the lid is inverted;
c. fitting the product display portion to the inverted lid so as to enclose the products;
d. bringing a press in to contact with an exterior surface of the base of the product display portion to produce a plurality of protrusions extending inwardly of the container from the plane of the base.

33. A method as claimed in claim 32, in which the step of pressing the exterior surface of the base of the product display portion is carried out before the product display portion is fitted to the lid.

34. A method as claimed in claim 32, in which the step pressing the exterior surface of the base of the product display portion is carried out after the product display portion is fitted to the lid.

35.-38. (canceled)

39. A method as claimed in claim 32, the method comprising transporting and/or storing the filled container on its lid.

40. A method as claimed in claim 32, the method comprising:
a. turning the filled container upright;
b. removing the lid so as to leave the products contained within the product display portion;
c. displaying the products in the product display portion.

41.-44. (canceled)
